(19) United States
(12) Patent Application Publication
(10) Pub. No.: US 2018/0151007 A1
(43) Pub. Date: May 31, 2018

(54) ONE-KEY VAULT

(71) Applicant: ASSA ABLOY AB, Stockholm (SE)

(72) Inventors: Fredrik Carl Stefan EINBERG, Huddinge (SE); Philip HOYER, Richmond (GB); Daniel BERG, Sundbyberg (SE)

(21) Appl. No.: 15/569,180

(22) PCT Filed: May 2, 2016
(86) PCT No.: PCT/EP2016/059747

§ 371 Date: Oct. 25, 2017

Related U.S. Application Data
(60) Provisional application No. 62/155,759, filed on May 1, 2015.

(51) Int. Cl. G07C 9/00; G06K 7/10

(52) U.S. Cl. CPC G07C 9/00111; G06K 7/10366

(57) ABSTRACT

An access control system enabling the use of a single mobile device with a plurality of keys is described. The plurality of keys are described as being stored in a key vault that is particularly administered by a holder of the mobile device and/or an enterprise that is granting the holder of the mobile device access to enterprise assets. By utilizing the key vault described herein, the holder of the mobile device does not need to carry separate access credentials or physical keys.

### CROSS REFERENCE TO RELATED APPLICATIONS

The present application claims the benefits of and priority, under 35 U.S.C. § 119(e), to U.S. Provisional Application Ser. No. 62/155,759, filed on May 1, 2015, entitled “One-Key Vault”, the disclosure of which is hereby incorporated by reference in its entirety for all that it teaches and for all purposes.

### FIELD

The present disclosure is generally directed to access control systems and more specifically to devices that are configured to operate in access control systems.

### BACKGROUND

Access control systems traditionally utilized Radio Frequency Identification (RFID) communication protocols such as ISO/IEC 15693, 14443A, 14443B, and the like and relied primarily upon RFID readers and RFID credentials. Various types of form factors have been used for RFID credentials such as cards, key fobs, stickers, etc. The paradigm for access control systems is shifting away from the traditional credential form factors, however.

In particular, the proliferation of smartphones, wearable devices, and other portable personal electronics has forced access control systems to adapt. In some circumstances, the access control systems have adapted by modifying readers to work with particular portable devices using a particular communication protocol (e.g., replacing old readers with new readers). In some circumstances, specific portable devices are deployed to work with old readers (e.g., utilizing Near-Field Communications (NFC)-compliant phones to communicate with readers using traditional ISO standards). In either situation, the concept of the access control system is being redefined.

As portable devices such as smartphones, wearable devices, and the like continue to gain market acceptance, a user's world is beginning to center around their portable devices. In particular, studies have shown that people are more likely to realize they have lost their smartphone before they realize they have lost their wallet. Further still, as mobile wallet technologies develop for smartphones and the like, a user's universe will almost certainly revolve around their personal portable devices or a single personal portable device.

It is anticipated that users will begin to rely on their personal portable device as their primary and, in some situations sole, device for communications, finance management, and access control. In other words, it is anticipated that many users will prefer to utilize their personal portable device as a replacement for their physical keys (e.g., house keys, work keys, gym keys, hotel keys, etc.) and credentials (e.g., work badge, visitor badge, passport, drivers' license, bus pass, etc.).

### SUMMARY

Understanding this desire, it is an aspect of the present disclosure to provide an access control solution whereby a user's mobile device is equipped and enabled to serve as a repository for multiple access control keys and other information. In particular, embodiments of the present disclosure deploy a personal portable device or mobile device that includes a key vault. The key vault includes a secure area for storing a plurality of different access control keys that may enable a holder of the mobile device to obtain access to physical and/or logic assets (e.g., locked doors, buildings, rooms, safes, computers, computer networks, financial accounts, etc.). The keys stored in the key vault may be securely administered by the user and/or by an administrator responsible for security of assets associated with the keys. For example, a user's key vault may include both personal keys (e.g., house keys, car keys, etc.) that are under administration by the user as well as enterprise keys (e.g., work keys, hotel keys, etc.) that are under administrator by an enterprise administrator or security personnel. However, the keys are accessible and useable in such a way that the user experience does not vary drastically between utilization of personal keys or enterprise keys.

In some embodiments, each key stored in the key vault may utilize a particular and defined communication channel or physical medium. Each key may also utilize a particular and defined communication protocol or set of communication protocols. Each key may also be configured to communicate with a particular and defined reader or set of readers (or restricted from communicating with a particular and defined reader or set of readers). Thus, each key stored in the key vault may be unique and specific to a particular service provider and the permissions or capabilities of that key may be suited to the particular service provider.

It is one aspect of the present disclosure to provide a key vault for all access control credential information, thereby enabling a user to have a single device for all of their access control needs. The keys may be stored as digital certificates in a secure memory device and access to the keys may be restricted with any number of techniques (e.g., PIN, passwords, fingerprint, other biometric templates, location/geofencing, contextual security, etc.). Access to the keys may also be controlled by securing the key vault itself. For instance, a reader may be required to authenticate with a mobile device before the reader is allowed to access any key within the key vault. In some embodiments, a vault identifier (“vault ID”) may be connected to a user. In this particular example, the mobile device may deliver the vault ID to the reader. The vault ID may be used by the reader to determine the types or kinds of keys that are or may be stored in the vault, without actually revealing details about the keys. With this information, the reader may issue a request for a particular key and not ask for other keys thereby enabling the reader to know what information should be requested from the mobile device and whether a particular key should be requested from the mobile device.

In some embodiments, a mobile device is provided that comprises:

computer memory including a secure area that is configured to store a plurality of access control keys; and

a reader interface that enables the mobile device to deliver one or more of the plurality of access control keys to a reader based on at least one of: (i) a communication channel used between the mobile device and reader; (ii) a protocol used between the mobile device and reader; (iii) an identity of the reader; (iv) a pairing between the mobile device and a peripheral device; (v) a context determined by the mobile device; (vi) a pairing between the mobile device and a user of the mobile device; (vii) a selection made by the reader; and (viii) a history of interactions between the mobile device and the reader.

In some embodiments, each of the plurality of access control keys stored in the secure area comprise different properties and at least two of which are administered by different entities.

In some embodiments, a first access control key from the plurality of access control keys is used in a first physical access control system and a second access control key from the plurality of access control keys is used in a second physical access control system.

The terms “memory,” “computer memory,” and “computer-readable medium,” as used herein, refer to any tangible data storage medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read instructions. When the computer-readable medium is configured as part of a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

As used herein, “credentials” or “credential information” refer to any data, set of data, encryption scheme, key, and/or transmission protocol used by a particular device (e.g., a “mobile device” or “wearable device”) to authenticate and/or to verify its authenticity with a reader, mobile device, and/or interrogator.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine,” “calculate,” and “compute,” and variations thereof as used herein, are used interchangeably and include any type of methodology, process, mathematical operation, or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a diagram depicting an access control system in accordance with embodiments of the present disclosure;

FIG. 2 is a block diagram depicting details of a mobile device in accordance with embodiments of the present disclosure;

FIG. 3 is a block diagram depicting details of a key vault in accordance with at least some embodiments of the present disclosure;

FIG. 4 is a flow diagram depicting a method for utilizing a key vault in connection with a data exchange between a mobile device and reader in accordance with at least some embodiments of the present disclosure;

FIG. 5 is a flow diagram depicting a method for determining which among several keys in a key vault to provide to a reader in accordance with embodiments of the present disclosure;

FIG. 6 is a flow diagram depicting a method for using mobile keys based on a binding of a mobile device with a peripheral device in accordance with at least some embodiments of the present disclosure;

FIG. 7 is a flow diagram depicting a method for adjusting an order of key usage in accordance with at least some embodiments of the present disclosure;

FIG. 8 is a flow diagram depicting a method of enabling a user selection of mobile keys in accordance with embodiments of the present disclosure;

FIG. 9 is a flow diagram depicting a method of maintaining a backup of a key vault in accordance with at least some embodiments of the present disclosure;

FIG. 10 is a flow diagram depicting a method of storing a key maintenance paradigms in accordance with at least some embodiments of the present disclosure;

FIG. 11 is a block diagram depicting a second example of a key vault in accordance with at least some embodiments of the present disclosure;

FIG. 12 is a flow diagram depicting a method of generating a key audit trail in accordance with at least some embodiments of the present disclosure; and

FIG. 13 is a flow diagram depicting a method of presenting a group audit trail to a requestor in accordance with at least some embodiments of the present disclosure.

### DETAILED DESCRIPTION

### Copyright and Legal Notices

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

One advantage of mobile devices as credentials, as opposed to, for example, RFID tags, is that mobile devices are generally capable of beyond-near-field communications using communication protocols such as Bluetooth, BLE, WiFi, ZigBee, infrared, sound, light, etc. In access control systems comprising a reader configured to communicate with a mobile device using one or more such communication protocols, the mobile device can communicate information to the reader even when it is not in close proximity to (e.g., more than 1.0 m away from) the reader. Additionally, storing credentials on mobile devices, which users typically carry (or wear) for other purposes, allows users to carry fewer objects. And mobile devices are typically equipped with various sensors not included in traditional RFID tags. Still further, mobile devices typically have greater processing power than traditional RFID tags. As described herein, these advantages may be exploited to allow an access control system to determine whether a particular individual is entering into or exiting out of a protected resource.

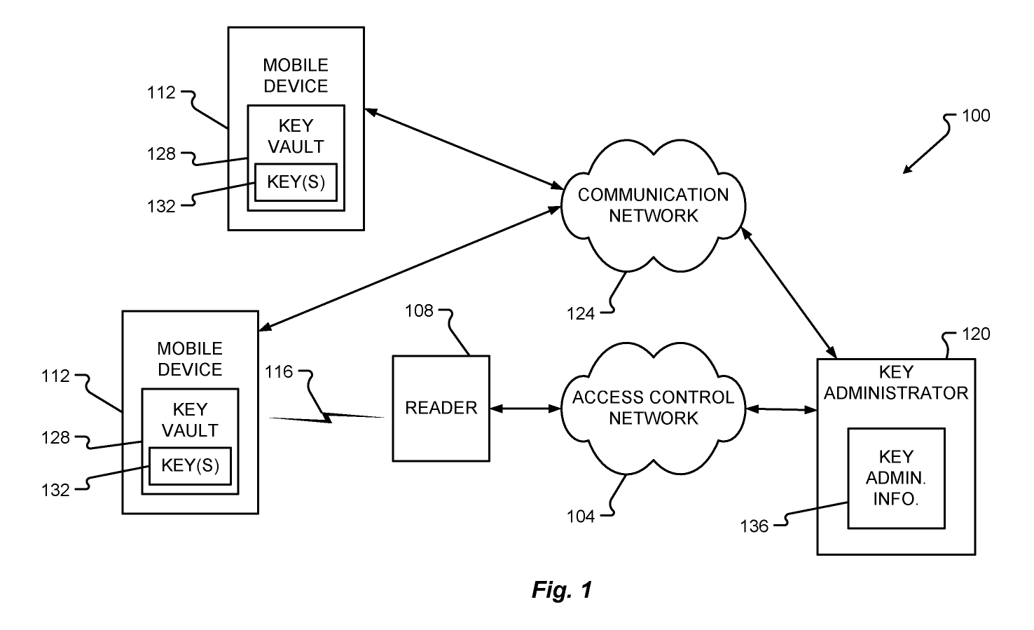

With reference now to FIGS. 1-13, various details and features related to an access control system and methods of operating the same will be described in accordance with at least some embodiments of the present disclosure. With initial reference to FIG. 1, a system 100 will be described in accordance with at least some embodiments of the present disclosure. The system 100 is shown to include an access control network 104 and a communication network 124. Although depicted as two separate and distinct networks, it should be appreciated that the networks 104, 124 may be implemented as a single network without departing from the scope of the present disclosure. The access control network 104 may provide connectivity between a plurality of readers 108 and a control panel or host computer, which is depicted as key administrator 120. The access control network 104 may use any type of known communication protocol to carry information between readers 108 and the key administrator 120. Non-limiting examples of the protocols or networks that may be used within access control network 104 include RS-232, RS-485, Wiegand, Ethernet, Power over Ethernet (PoE), ZigBee, Wi-Fi (e.g., IEEE 802.11, variants thereof or extensions thereto), an Internet Protocol (IP) network, or any other type of wired or wireless protocol.

The communication network 124 may correspond to a private, semi-private, or public communication network used to carry information between compatible communication devices. Non-limiting examples of a communication network 124 include a telephone network, a cellular network, an IMS network, a Wide Area Network (e.g., the Internet), a Local Area Network, an IP network, an SNMP network, or any other known type of network architecture. One or more of email messages, SMS messages, MMS messages, SNMP messages, messages transmitted using HTTP or SHTTP or variants thereof, messages exchanged using FTP, messages exchanged using RTP or UDP, or the like can be used to carry information between a mobile device 112 and key administrator 120. In some embodiments, Voice over IP (VoIP) or the like can also be used to carry information between the mobile device and key administrator 120.

The reader 108 may correspond to any type of interaction device or set of interaction devices that limit or control access to one or more protected assets. The reader 108, in some embodiments, may be configured to exchange communications directly with a mobile device 112 via a communications channel 116. The communications channel 116 may be a contactless communications channel in some embodiments. The communications channel 116 may alternatively or additionally be a contact-based communications channel. In some embodiments, electromagnetic radiation in the form of Radio Frequency (RF) waves may be used to carry information on the communications channel 116. Alternatively or additionally, the communications channel 116 may utilize light, magnetic, acoustic, or any other medium to carry information between the reader 108 and mobile device 112. The communication channel 116 may also be characterized by the communication protocol used to exchange information. In some embodiments, signal modulation (e.g., Amplitude Modulation, Frequency Modulation, Phase Modulation, combinations thereof variants thereof or the like) is used to communicate data between the reader 108 and mobile device 112. Some non-limiting examples of the protocol(s) that are used on the communication channel 116 include protocols defined in ISO 14443, ISO 15693, ISO 18092, FeliCa, Near Field Communications (NFC), Bluetooth, Wi-Fi (e.g., 802.11N, variants thereof or extensions thereto), ZigBee, GSM, combinations thereof, etc. It should further be appreciated that depending upon the capabilities of the mobile device 112 and reader 108, it may be possible to establish multiple communication channels 116 between the devices. For instance, the reader 108 and mobile device 112 may establish a first communication channel using a first protocol (e.g., Bluetooth or Bluetooth Low Energy (BLE)) as well as a second communication channel using a second protocol (e.g., NFC, infrared, or the like). It should be appreciated that the communication channel 116 may correspond to a proximity-based communication channel that can only be created when the mobile device 112 and reader 108 are within a predetermined distance of one another (e.g., less than 0.5 meters for NFC, less than 50 meters for BLE, or less than 200 meters for Wi-Fi). The communication channel 116 may be further characterized by the authentication protocol used by the devices (e.g., reader 108 and mobile device 112) to authenticate with one another. Examples of authentication protocols that may be used on the communication channel 116 include SEOS and FIDO. As will be discussed in further detail herein, depending upon the nature or characteristics of the communication channel 116, the mobile device 112 may alter or control which, if any, keys 132 from its key vault 128 are communicated to the reader 108 over the communication channel 116.

The mobile device 112 may correspond to any type of electronic device and, as the name suggests, the electronic device may be portable in nature. As some examples, the mobile device 112 may correspond to a cellular phone or smartphone carried by a user. Other examples of a mobile device 112 include, without limitation, wearable devices (e.g., glasses, watches, shoes, clothes, jewelry, wristbands, stickers, etc.). The mobile device 112, as shown in FIG. 1, may be provided with a key vault 128 that stores one or a plurality of keys 132. The key(s) 132 may be communicated to a reader 108 in connection with a holder of the mobile device 112 attempting to gain access to an asset protected by the reader 108. As an example, the mobile device 112 may be presented to the reader 108 by a user or holder of the mobile device 112.

If NFC is being used for the communication channel 116, then the reader 108 and mobile device 112 may have their interfaces/antennas inductively coupled to one another at which point the reader and/or mobile device 112 will authenticate or mutually authenticate with one another. Following authentication, the reader 108 may request a key 132 or multiple keys from the mobile device 112 or the mobile device 112 may offer a key 132 or multiple keys to the reader 108. Upon receiving the key(s) 132 from the mobile device 112, the reader 108 may analyze the key(s) 132 and determine if the key(s) 132 are valid and, if so, allow the holder/user of the mobile device 112 access to the asset protected by the reader 108. It should be appreciated that the mobile device 112 may alternatively or additionally be configured to analyze information received from the reader 108 in connection with making an access control decision and/or in connection with making a decision whether or not to provide key(s) 132 to the reader 108. Examples of technologies that can be used by the mobile device 112 to make an access control decision for itself are further described in U.S. Pat. No. 8,074,271 to Davis et al. and U.S. Pat. No. 7,706,778 to Lowe, both of which are hereby incorporated herein by reference in their entirety.

If BLE or some other non-inductive protocol (e.g., Wi-Fi) is being used for the communication channel 116, then the reader 108 and mobile device 112 may perform a discovery routine prior to pairing with one another or otherwise connecting to establish the communication channel 116. After the channel 116 is established, however, the reader 108 and mobile device 112 may then authenticate one another and exchange relevant information, such as the key(s) 132, to enable an access control decision to be made. If a positive access control decision is made (e.g., it is determined that the key(s) 132 are valid and the mobile device 112 is allowed to access the asset protected by the reader 108), then the reader 108 may initiate one or more actions to enable the holder/user of the mobile device 112 to access the asset protected by the reader 108.

As can be seen in FIG. 1, the key administrator 120 may be provided with key administration information 136 that enables the key administrator 120 to control or otherwise administer certain properties or privileges associated with the key(s) 132 that are eventually stored in the key vault 128. The key administrator 120 may be capable of administering, controlling, and/or delivering key(s) to mobile devices 112 via the communication network 124 and/or via the access control network 104. If the access control network 104 is used to administer, control, and/or deliver key(s) to mobile devices 112, then the reader 108 may also be used as a conduit for communication between the key administrator 120 and mobile device 112. In some embodiments, the key administrator 120 may be implemented as a server, collection of servers, a host computer, a control panel, a personal computer, a laptop, or the like. The key administrator 120 may also correspond to an entity that distributes keys on behalf of an owner of the mobile device 112 or an enterprise (e.g., hotel booking department, corporate security personnel, network security personnel, etc.) based on requests for keys received from the owner of the mobile device 112 or the enterprise.

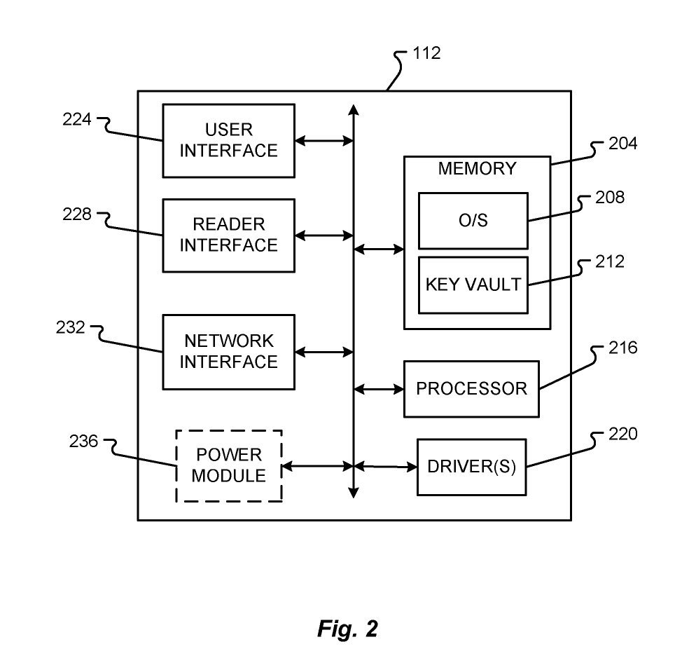

With reference now to FIG. 2, additional details of a mobile device 112 will be described in accordance with at least some embodiments of the present disclosure. The mobile device 112 is shown to include computer memory 204 that stores one or more Operating Systems (O/S) 208 and a key vault 212, among other items. The mobile device 112 is also shown to include a processor 216, one or more drivers 220, a user interface 224, a reader interface 228, a network interface 232, and a power module 236. Suitable examples of a mobile device 112 include, without limitation, smart phones, PDAs, laptops, PCs, tablets, net books, wearable devices, and the like.

The memory 204 may correspond to any type of non-transitory computer-readable medium. In some embodiments, the memory 204 may comprise volatile or non-volatile memory and a controller for the same. Non-limiting examples of memory 204 that may be utilized in the mobile device 112 include RAM, ROM, buffer memory, flash memory, solid-state memory, or variants thereof.

The O/S 208 may correspond to one or multiple operating systems. The nature of the O/S 208 may depend upon the hardware of the mobile device 112 and the form factor of the mobile device 112. The O/S 208 may be viewed as an application stored in memory 204 that is processor-executable. The O/S 208 is a particular type of general-purpose application that enables other applications stored in memory 204 (e.g., a browser, an email application, an SMS application, etc.) to leverage the various hardware components and driver(s) 220 of the mobile device 112. In some embodiments, the O/S 208 may comprise one or more APIs that facilitate an application's interaction with certain hardware components of the mobile device 112. Furthermore, the O/S 208 may provide a mechanism for viewing and accessing the various applications stored in memory 208 and other data stored in memory 208.

The key vault 212 may be similar or identical to the key vault 128. In some embodiments, the key vault 212 may be stored in the same physical memory 204 as the O/S 208. In other embodiments, the key vault 212 may be stored in physical computer memory that is separate from the computer memory used to store the O/S 208 and other applications. Even more specifically, the key vault 212 may be kept in secure or encrypted computer memory, thereby preventing the keys contained therein from being obtained or manipulated by unauthorized parties. As will be discussed in further detail herein, access to the key vault 212 may be predicated upon certain events and/or user inputs. For instance, a user may be required to input a valid password or PIN at the user interface 224 for the key vault 212 to open and allow access to the key(s) contained therein. Alternatively or additionally, the key vault 212 may not be opened unless and until a valid input is received from the reader 108. Other factors that may be used to determine whether to open the key vault 212 include location information (for the mobile device 112), contextual information, historical use information for the mobile device, biometric information from the user of the mobile device 112, etc.

The processor 216 may correspond to one or many microprocessors that are contained within the housing of the mobile device 112 with the memory 204. In some embodiments, the processor 216 incorporates the functions of the user device's 108 Central Processing Unit (CPU) on a single Integrated Circuit (IC) or a few IC chips. The processor 216 may be a multipurpose, programmable device that accepts digital data as input, processes the digital data according to instructions stored in its internal memory, and provides results as output. The processor 216 implement sequential digital logic as it has internal memory. As with most known microprocessors, the processor 216 may operate on numbers and symbols represented in the binary numeral system.

The driver(s) 220 may correspond to hardware, software, and/or controllers that provide specific instructions to hardware components of the mobile device 112, thereby facilitating their operation. For instance, the user interface 224, reader interface 228, and network interface 232, may each have a dedicated driver 220 that provides appropriate control signals to effect their operation. The driver(s) 220 may also comprise the software or logic circuits that ensure the various hardware components are controlled appropriately and in accordance with desired protocols. For instance, the driver 220 of the reader interface 228 may be adapted to ensure that the reader interface 228 follows the appropriate proximity-based protocols (e.g., BLE, NFC, Infrared, Ultrasonic, IEEE 802.11N, etc.) such that the reader interface 228 can exchange communications with the credential 112. Likewise, the driver 220 of the network interface 232 may be adapted to ensure that the network interface 232 follows the appropriate network communication protocols (e.g., TCP/IP (at one or more layers in the OSI model), UDP, RTP, GSM, LTE, Wi-Fi, etc.) such that the network interface 232 can exchange communications via the communication network 104. As can be appreciated, the driver(s) 220 may also be configured to control wired hardware components (e.g., a USB driver, an Ethernet driver, etc.).

As mentioned above, the user interface 224 may comprise one or more user input devices and/or one or more user output devices. Examples of suitable user input devices that may be included in the user interface 224 include, without limitation, buttons, keyboards, mouse, pen, camera, microphone, etc. Examples of suitable user output devices that may be included in the user interface 224 include, without limitation, display screens, lights, speakers, etc. It should be appreciated that the user interface 224 may also include a combined user input and user output device, such as a touch-sensitive display or the like.

The reader interface 228 may correspond to the hardware that facilitates communications with the credential 112 for the mobile device 112. The reader interface 228 may include a Bluetooth interface (e.g., antenna and associated circuitry), a Wi-Fi/802.11N interface (e.g., an antenna and associated circuitry), an NFC interface (e.g., an antenna and associated circuitry), an Infrared interface (e.g., LED, photodiode, and associated circuitry), and/or an Ultrasonic interface (e.g., speaker, microphone, and associated circuitry). In some embodiments, the reader interface 228 is specifically provided to facilitate proximity-based communications with a credential 112 via communication channel 116 or multiple communication channels 116.

The network interface 232 may comprise hardware that facilitates communications with other communication devices over the communication network 104. As mentioned above, the network interface 232 may include an Ethernet port, a Wi-Fi card, a Network Interface Card (NIC), a cellular interface (e.g., antenna, filters, and associated circuitry), or the like. The network interface 232 may be configured to facilitate a connection between the mobile device 112 and the communication network 104 and may further be configured to encode and decode communications (e.g., packets) according to a protocol utilized by the communication network 104.

The power module 236 may include a built-in power supply (e.g., battery) and/or a power converter that facilitates the conversion of externally-supplied AC power into DC power that is used to power the various components of the mobile device 112. In some embodiments, the power module 236 may also include some implementation of surge protection circuitry to protect the components of the mobile device 112 from power surges.

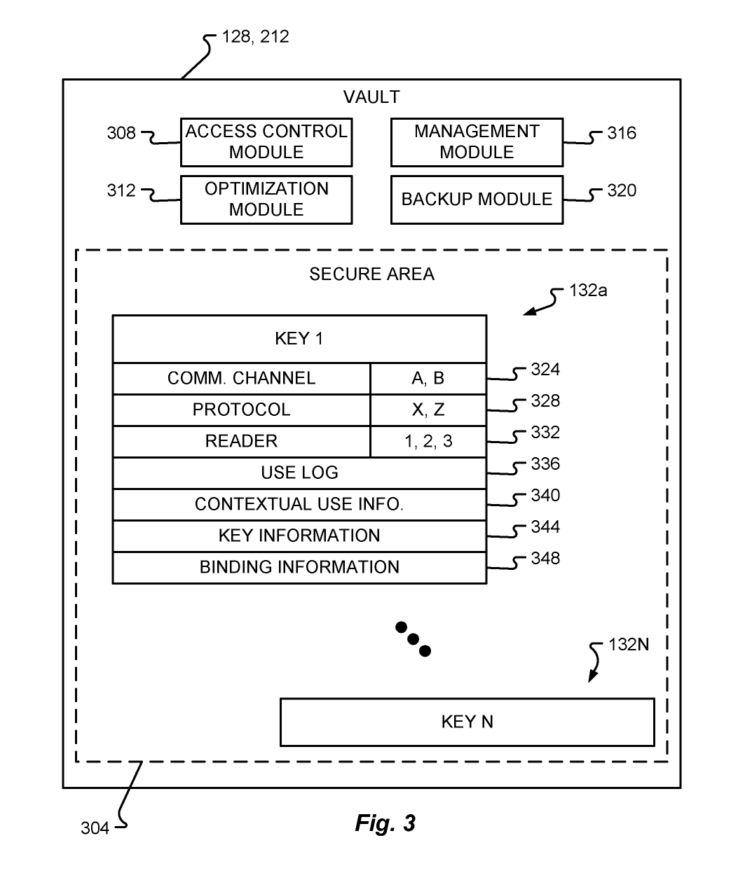

With reference now to FIG. 3, additional details of the key vault 128, 212 will be described in accordance with at least some embodiments of the present disclosure. The key vault 128, 212 is shown to include a secure area 304 and a non-secure area (e.g., the area not encompassed within the secure area 304). However, as discussed above, the entire vault 128, 212 may be stored in encrypted memory, in which case the entire vault is contained within a secure area.

The vault 128, 212 is shown to include an access control module 308, an optimization module 312, a management module 316, and a backup module 320. These modules may be stored as computer-readable instructions that are executable by the processor 216. Alternatively, one or more of the modules may be stored separate from the vault and used to manage operations of the vault, including access to the vault and which keys 132 should be distributed to external devices. The access control module 308, in particular, may be configured to control overall access to the secure area 304. Unless a valid input or set of inputs is received at the mobile device 112, then the access control module 308 will not open the vault and expose the keys contained therein. The access control module 308 may also be responsible for analyzing external inputs and other data to determine which key or set of keys should be provided to an external device (e.g., the reader 108).

The optimization module 312 may be configured to optimize behavior of the access control module 308 in addition to optimizing the storage of keys 132 within the vault 128, 212. As an example, the optimization module 312 may monitor the use of keys 132 as well as the circumstances under which keys are used and/or distributed by the mobile device 112. If the optimization module 312 is able to detect a pattern of use (e.g., a particular key is sent to a particular reader or a particular key is used more frequently than other keys or a particular communication protocol is used more frequently thereby causing a particular key to be used more frequently or a particular key is sent when the mobile device 112 is at or near a particular location, etc.), then the optimization module 312 may cause an order with which keys are sent or advertised to a reader 108 to be altered. In some embodiments, the order with which keys are sent or advertised may be optimized to minimize interaction time between the reader 108 and mobile device 112.

The management module 316 may correspond to a module within the mobile device 112 that manages the secure area 304 and the keys 132 contained therein. The management module 316 may respond to requests and commands transmitted by the key administrator 120 and implement actions consistent with those requests and commands. For instance, if the key administrator 120 instructs a mobile device 112 to erase a key 132 from its memory, then the management module 316 may be the component responsible for actually erasing, removing, or overwriting the memory location where the key was stored. As another example, if the key administrator 120 instructs the mobile device 112 to write a new key thereto or update parameters of an existing key, then the management module 316 may be the component responsible for writing the new key to the secure area 304 or modifying the parameters of an existing key stored in the secure area 304.

The backup module 320 may correspond to a module within the mobile device 320 that manages backup and restoration of keys 132 in the vault 128, 212. In particular, the backup module 320 may be responsible for establishing communications with an appropriate remote backup entity or database (which may or may not correspond to the key administrator 120). The backup module 320 may also be responsible for communicating information to the remote backup entity that enables the keys 132 to be backed up in an appropriate fashion. In some embodiments, the keys 132 may not actually be sent to the remote backup entity, but instead identifiers or descriptors of the keys 132 may be provided to the backup entity. By providing appropriate identifiers or descriptors of the keys 132, the remote backup entity may have an understanding of the keys that belong to a particular mobile device 112. Furthermore, if the remote backup entity corresponds to the key administrator 120, then the key administrator 120 will have the additional necessary information for the keys that were originally written to the vault 128, 212. As will be discussed in further detail herein, if a mobile device 112 is lost or otherwise compromised, then the keys 132 stored on that mobile device 112 may be deactivated by the backup module 320 and new keys may be issued in replacement thereof.

A plurality of keys 132a-N are shown as being contained in the vault 128, 212. It should be appreciated that the vault 128, 212 can be configured to contain a single key without departing from the scope of the present disclosure. It should also be appreciated that the number of keys, N, stored in the vault 128, 212 can be any integer number greater than or equal to one and is limited only by the size constraints of the memory 204.

Each key 132 may comprise one or more fields to store parameters or characteristics that describe the key 132 as well as conditions under which the key 132 can be used. Non-limiting examples of the fields that may be included as part of a key 132 data structure include a channel field 324, a protocol field 328, a reader identifier field 332, a use log 336, a contextual use information field 340, a key information field 344, and a binding information field 348.

The communication channel field 324 may contain information describing the type(s) of communication channels over which the key 132 is allowed to be distributed (e.g., channels A and B are shown to be authorized channels for the first key 132a). For instance, some keys 132 may only be allowed to be transmitted over very short distances (e.g., an NFC communication channel) whereas other keys may be allowed to be transmitted over relatively long distances (e.g., a Wi-Fi communication channel). Of course, the protocols listed in the communication channel field 324 may correspond to a black list of channels (e.g., restricted channels) instead of a white list of channels (e.g., allowable channels).

The protocol field 328 may contain information describing the protocol(s) that can be used to distribute a key 132 (e.g., protocols X and Z are shown to be authorized protocols for the first key 132a). Protocols may correspond to communication or data-exchange protocols (e.g., NFC, BLE, Wi-Fi, Zigbee, UHF, etc.) and/or to authentication protocols (e.g., SEOS, FIDO, etc.). In the example depicted, some of the keys 132 may correspond to enterprise keys (e.g., keys to obtain access to enterprise assets, such as an office) and other keys may correspond to personal keys (e.g., keys to obtain access to personal assets, such as a house). The enterprise keys may use one authentication protocol (e.g., SEOS) whereas the personal keys may use another authentication protocol (e.g., FIDO). Of course, the protocols listed in the protocol field 328 may correspond to a black list of protocols (e.g., restricted protocols) instead of a white list of protocols (e.g., allowable protocols).

The reader identifier field 332 may comprise a reader control list (e.g., a listing of readers) that are either allowed to have they key 132 provided thereto or are restricted from having the key 132 provided thereto. Alternatively or additionally, the reader identifier field 332 may comprise information that describes properties of locations of readers that are allowed to receive or disallowed from receiving a key 132.

The use log 336 may comprise information describing specific uses or attempted uses of the key 132. The use log 336 may also comprise information describing which readers 108 have been provided with the key 132, which readers 108 have requested the key 132, which readers 108 have been proactively provided with a key 132, times and/or dates when the key 132 was provided to a reader 108, results of an access control decision (by either the reader 108 or the mobile device 112) when the key 132 was used, and the like. The use log 336 may correspond to a repository for key usage information and, in some embodiments, may serve as a basis for audit trails for individual keys. When combined with use logs 336 from other keys, the combined use logs 336 may be used to generate a collection of key use data for an access control system.

The contextual use information field 340 may correspond to a field that stores historical contextual use information for a key 132 and/or permitted contexts under which the key 132 may be used. As an example of historical contextual use information, the field 340 may comprise data describing a location, temperature, date, and other environmental information during the time that a key 132 was used or distributed. As an example of permitted contexts, the contextual use information field 340 may define that the key 132 can only be used when the mobile device 112 is in a particular location (or within a predefined geographical boundary) or in the presence of some other predetermined environmental condition.

The key information field 344 may comprise information that describes a key 132, intended uses of a key 132, and other information traditionally included in or on a portable credential. For instance, the key information field 344 may carry a site code (e.g., a code identifying a site or sites at which the key can be used), a manufacturer identifier, an identifier of the key administrator 120 responsible for administering the key 132, etc. Any other information used to describe the key 132, either within the vault (e.g., memory location) or at the remote backup location can also be contained in the key information field 344.

The binding information field 348 may comprise information that describes binding requirements associated with the key 132. For example, the binding information field 348 may comprise information that requires the mobile device 112 be “bound” to a particular user, meaning that a particular user must be logged into the mobile device 112 for a key 132 to work. As another example, the binding information field 348 may comprise information that requires the mobile device 112 to be bound to another peripheral device (e.g., a wearable device, a second mobile device, etc.) for a key 132 to be distributed or used. Binding may be achieved by detecting a presence of the required element (user or peripheral device) within a predetermined distance of the mobile device 112. Binding may also be achieved by creating a communication channel or pairing between the mobile device 112 and peripheral device.

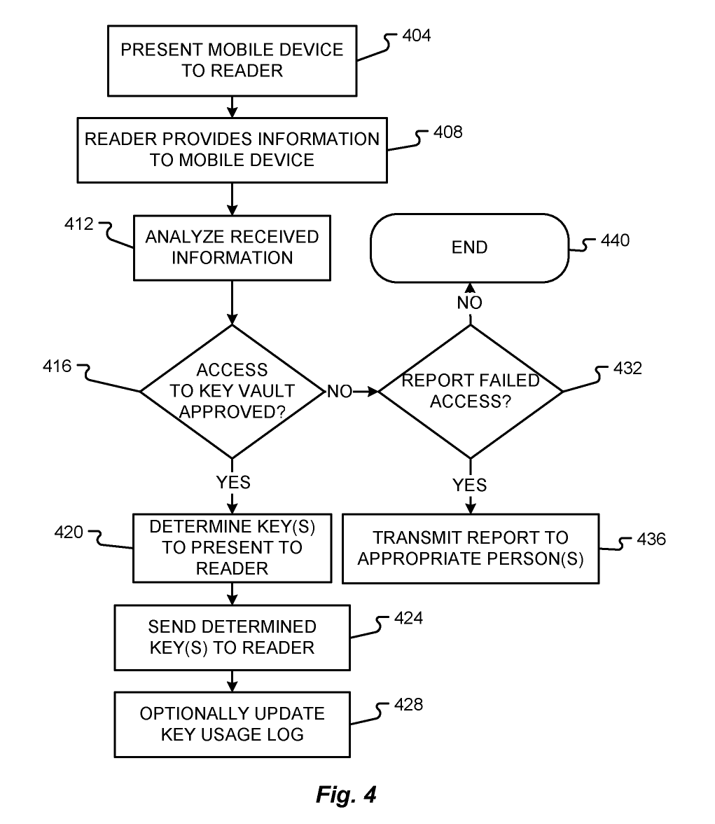

With reference now to FIG. 4, an illustrative method of utilizing one or more keys from a key vault will be described in accordance with at least some embodiments of the present disclosure. The method begins when a mobile device is presented to a reader (step 404). A communication channel is then established between the mobile device and reader. The communication channel may initially be established for the purposes of authenticating the devices. In other embodiments, the communication channel is established as part of the authentication process. Thereafter, the reader provides information to the mobile device (step 408). For instance, the reader may provide the mobile device with its identification information (e.g., a reader ID), a location of the reader, a model number or type of reader, and other information that describes the reader.

The mobile device then analyzes the information received from the reader (step 412) to determine if the reader is allowed to access one or more keys in the key vault of the mobile device (step 416). If the query to step 416 is answered affirmatively, then the vault is opened and the mobile device begins the process of determining which key(s) to provide to the reader (step 420). In some embodiments, the decision as to which key(s) are going to be provided to the reader can include an analysis of: (i) a communication channel used between the mobile device and reader; (ii) a protocol used between the mobile device and reader; (iii) an identity of the reader; (iv) a pairing between the mobile device and a peripheral device; (v) a context determined by the mobile device; (vi) a pairing between the mobile device and a user of the mobile device; (vii) a selection made by the reader; and (viii) a history of interactions between the mobile device and the reader. The method continues with the mobile device sending the determined key(s) to the reader (step 424) and then optionally updating its key usage log 336 (step 428).

Referring back to step 416, if the query is answered negatively, then it is determined if the failed access attempt to the key vault is to be reported (step 432). If that query is answered negatively, then the method ends (step 440). However, if the query is answered affirmatively, then the method proceeds with the mobile device and/or reader transmitting an appropriate report to one or more predetermined persons (step 436). The report may include an identifier of the key vault, an identifier of a key that was requested by the reader, an identifier of the reader, and any other information pertaining as to why the key was requested and/or why access to the key was denied.

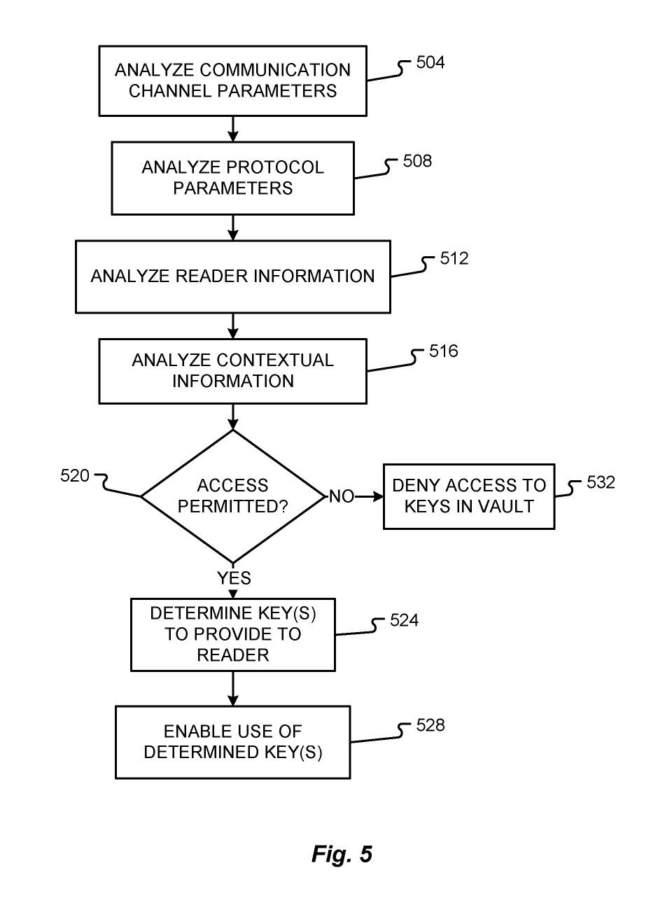

With reference now to FIG. 5, a method of selectively enabling use of one or more keys when a key vault has been opened will be described in accordance with at least some embodiments of the present disclosure. The method begins when a key vault is opened and then the access control module of the vault analyzes the communication channel parameters existing between the mobile device and reader (step 504). The analysis may be performed for one or multiple channels, depending upon the number of channels existing between the reader and mobile device. The access control module may also be configured to analyze the protocol parameters, reader information, and other contextual information (e.g., location, etc.) surrounding the communication channel(s) established between the reader and mobile device (steps 508, 512, 516). Other information such as binding information and the like may also be analyzed in these steps.

Based on the analysis of the communication channel, protocol, reader information, and contextual information, the access control module determines if the reader is allowed access to one or more keys within the vault (step 520). If so, the access control module determines which keys to provide to the reader (or allow the reader to otherwise access) (step 524) and then enables the use of the determined key(s) (step 528). In some embodiments, the mobile device may only provide the key to the reader using the valid communication channel and protocol. Thus, if the reader was unable to establish an appropriate communication channel or utilize an appropriate protocol, the reader will not be allowed to receive the key(s). If the access control module determines that no keys are to be provided to the reader, then the reader is denied access to any keys within the vault, even though the vault has been opened (step 532).

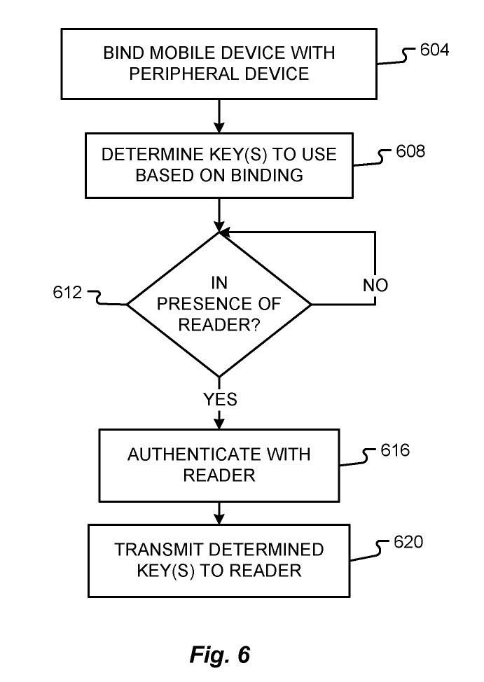

With reference now to FIG. 6, a method of controlling access to one or more keys in a key vault based upon binding information will be described in accordance with at least some embodiments of the present disclosure. The method begins when a mobile device is bound with a peripheral device (step 604). As noted above, the binding of the two devices may be achieved based on establishing a communication session therebetween, establishing a communication channel therebetween, determining the peripheral device is within a predetermined distance of the mobile device, mutually authenticating the mobile device and peripheral device to one another, etc.

The method continues with the access control module determining whether any keys stored in the key vault are usable based on the binding (step 608). Thereafter, the mobile device waits until it is within the presence of a reader and a communication channel has been established therewith (step 612). Once a reader is in communication with the mobile device, the method continues with the mobile device and reader authenticating with one another (or with the mobile device authenticating the reader) (step 616). Following authentication, the key(s) that were usable based on the binding of the mobile device with the peripheral can be transmitted to the reader (step 620). In some embodiments, these keys may be transmitted to the reader without receiving a request from the reader for the keys. Instead, the binding event, establishment of an appropriate communication channel, and authentication may correspond to the only required preconditions to transmitting the key(s) to the reader. Of course, the key(s) may also be transmitted in response to receiving a request for keys from the reader.

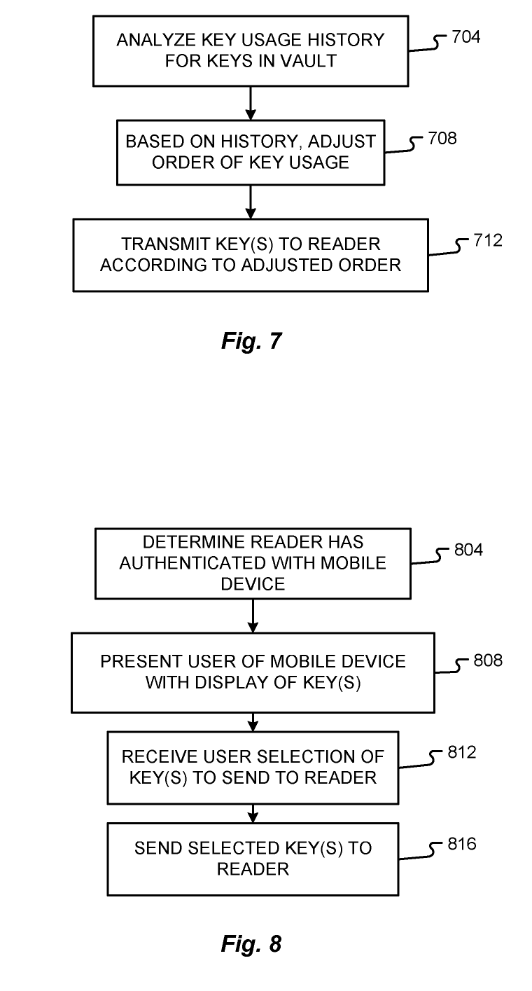

With reference now to FIG. 7, a method of analyzing key usage history and optimizing key utilization orders will be described in accordance with embodiments of the present disclosure. The method begins with the optimization module analyzing key usage history for one or multiple keys within a key vault (step 704). In some embodiments, this step may involve analyzing the specific key use information for each key in the vault. In other embodiments, this step may involve analyzing only a subset of key usage information. The information analyzed may include a relative number of uses for keys (e.g., key utilization frequency), time of day when a key or keys are used more frequently than others, day of week that particular keys are used (or not used), locations of the mobile device when a particular key or keys are used, etc.

Based on the analysis of the key usage history, the optimization module may adjust the order with which keys in the vault are used or presented to a reader (step 708). Then the mobile device is enabled to transmit the keys to readers based on the adjusted order (step 712). By optimizing the order of key presentation based on key usage history, the mobile device may be able to minimize transaction times with readers. Another adjustment that can be made is the order with which keys are analyzed by the access control module. As a non-limiting example, if a particular key is used more frequently than others in the vault, then the optimization module may cause the most-frequently-used key to be the first key analyzed by the access control module when a communication channel is established between the mobile device and reader. Thus, the likelihood of the first analyzed key being a key that is transmitted to the reader is increased, again minimizing the interaction time between the mobile device and reader.

With reference now to FIG. 8, a method of requesting a user for a selection of keys to provide to a reader will be described in accordance with at least some embodiments of the present disclosure. The method begins when it is determined that a reader has a mobile device come in communication range therewith and the two devices have authenticated with one another (step 804). In response to the authentication between the reader and mobile device, the method continues by presenting the user of the mobile device with icons representing one or more keys stored in the key vault (step 808). As can be appreciated, the presentation may include all of the keys stored in the key vault or only a subset thereof. If only a subset is presented, the subset may be selected based on any number of considerations. For instance, the user may only be presented with keys that are allowed to be shared over the communication channel between the reader and mobile device (e.g., based on communication channel characteristics, protocol characteristics, reader identity, contextual information, binding information, etc.). The order with which the keys are presented to the reader may correspond to a user-defined order or an optimized order based on key usage (e.g., present the most used keys first).

The user is allowed to navigate the presentation of icons (or other identification information such as hyperlinks, names, numbers, aliases, etc.) and eventually select one or more keys to provide to the reader (step 812). In response to the user selection, the mobile device transmits the selected key(s) to the reader (step 816).

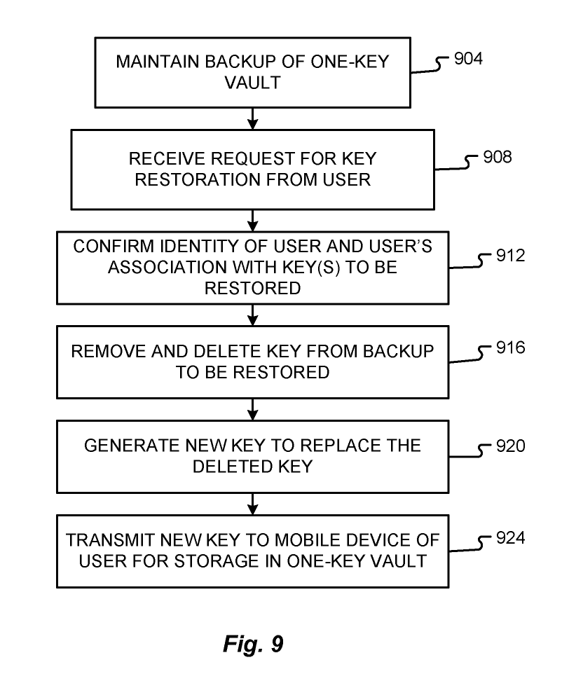

With reference now to FIG. 9, a method of maintaining a backup for keys or a key vault will be described in accordance with at least some embodiments of the present disclosure. The method begins by maintaining a backup of one or all keys stored in a key vault (step 904). The backup may include identifiers of the keys and/or sources that provided the keys to the mobile device. In some embodiments, it may not be desirable to maintain copies of keys (or enable keys to be copied) as such an allowance may expose an access control system to unwanted attacks.

The method continues when a request for key restoration is received from a user (step 908). The request may be received in response to the user purchasing a new mobile device (to replace their old mobile device), in response to the user losing their mobile device, and/or in response to a user having their mobile device compromised for any reason. In response to the request, the method continues with the remote backup system confirming the identity of the user that issued the request and, if applicable, the user's association with the key(s) to be restored (step 912). If the key corresponds to a personal/residential key owned and originally requested by the user, then the association between the user and key may be one of owner/administrator/purchaser. On the other hand, if the key is a work key not administered by the user, but rather an employer of the user, then the association between the user and key may be one of employee/user.

Once the user's identity and association is confirmed, the method continues by removing and deleting the requested key from the backup location (step 916). The method further continues by generating a new key to replace the deleted key (step 920). The newly-generated key is then transmitted to the mobile device of the user for storage in the key vault of the mobile device (step 924). In some embodiments, the key is transmitted to the mobile device from which the request was received. In some embodiments, the key is transmitted to a mobile device identified within the request (e.g., if the requestor was an administrator and the mobile device is one that is carried by the user).

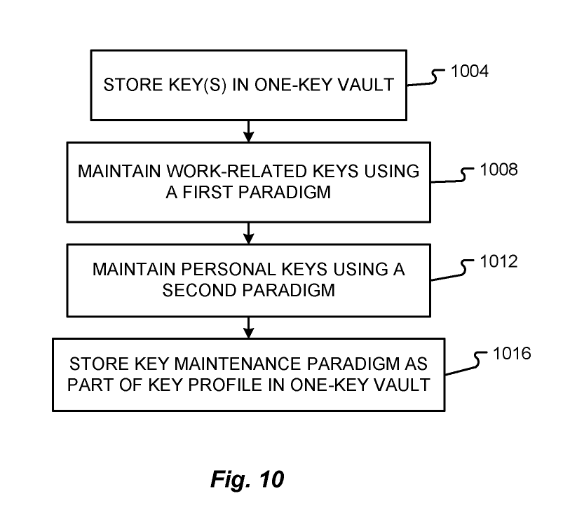

With reference now to FIG. 10, a method of maintaining and storing a plurality of keys according to different paradigms will be described in accordance with at least some embodiments of the present disclosure. The method begins by storing two or more keys in a key vault (step 1004). Work-related keys may be stored and maintained in the vault using a first management paradigm (step 1008) whereas personal keys are stored and maintained in the vault using a second management paradigm (step 1012). These key paradigms may be stored as part of the key profiles or data structures in the vault (step 1016). As used herein, the paradigms used for the work and personal keys may correspond to different ways of storing the keys (e.g., storing personal keys in predefined memory locations and work keys in other predefined memory locations), different ways of authenticating for the keys (e.g., FIDO versus SEOS), different ways of restoring the keys, different ways of backing up keys, different ways of administering keys, different ways of analyzing keys, etc.

As discussed herein, a vault ID may refer to something that a reader can read to obtain information about a key, without actually having access to the key or keys in a key vault. In other words, a vault ID may correspond to some identifier that is used by a key management system to determine what one-key vault the key management system is talking to. As a non-limiting example, a root ID for a particular one-key vault may be connected or otherwise associated with a particular user or user group. The primary use for the vault ID may be for the management of that particular vault. For instance, the vault ID may be made more secure by being constructed with an asymmetric key pair. The key pair can be generated by the one-key vault at production and the public key of the key pair could correspond to the vault ID itself. When a user registers their key to a remote key management system, the user is then bound with that particular vault ID (e.g., public key from the asymmetric key pair). When managing the key, the public key is sent to a reader or the like. The reader sends a message to be signed with the private key by the remote key management system. The message is then returned to the reader where the message is verified with the public key (e.g., the vault ID). If this analysis proves the key pair is valid, then the reader know that it is communicating with an approved vault having a genuine key and the one-key vault is, therefore, authenticated. For further communication between the remote key management system and the one-key vault at the root level, a symmetric session key (e.g., AES-128) could be generated. This key pair may remain valid until the session ends, at which point the key pair becomes obsolete. Root level functions would be to register new key access and maybe obtain metadata from existing access keys stored in the one-key vault. However, these root level functions may not include updating existing access keys. To update existing access keys, the remote key management system may be required to authenticate to the specific access key stored within the one-key vault. In other words, a layers approach may be used to authenticate on the root level using the vault ID (e.g., public key from the asymmetric key pair). Once authenticated and opened, then and only then may new keys be added to the vault. To change existing keys, a further authentication with the particular access keys may be required.

Further still, it may be possible to have several vaults on the same mobile device. Each vault may use its own unique/different vault ID. From production, there is only one vault; however, a third party may be allowed to add a new vault to the mobile device. The new vault may be isolated from the original vault vis-à-vis use of the vault IDs (e.g., public keys and unique key pairs). The end-user could then trigger the creation of a new vault thereby causing the one-key vault to generate a new asymmetric key pair. This may only be allowed if the end-user is logged into an original or already-existing vault. Once logged-in, the end user could then assign management rights to the vault to a third party, for example.

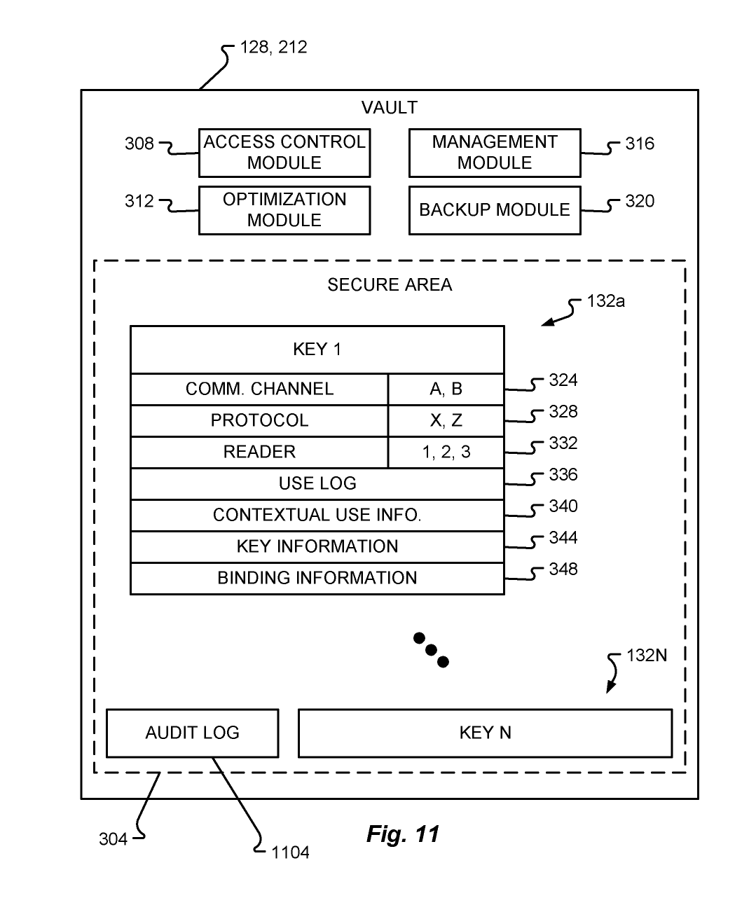

Referring now to FIG. 11, another example of a key vault 128, 212 will be described in accordance with at least some embodiments of the present disclosure. The vault 128, 212 is similar to other examples of a vault 128, 212 described herein. This particular vault 128, 212, however, is shown to include an audit log 1104 in the secure area 304. It should be appreciated that an audit log 1104 may correspond to a copy of the use log 336 that is stored in a different memory location. Alternatively or additionally, the audit log 1104 may be cryptographically secured, digitally signed, or otherwise provided with an authenticity certificate that indicates the audit log 1104 contains a true representation of activities encountered by the mobile device 112. As a non-limiting example, the audit log 1104 may be cryptographically secured with the nth key 132N, a derivative of the nth key 132N, some other key used to maintain data in the secure area 304, or the like.

It should also be appreciated that the audit log 1104 does not have to be stored in the memory of the mobile device 112. Instead, a single copy of the audit log 1104 (or pieces of the audit log 1104) may be stored in a reader 108, at a key administrator 120 site, or elsewhere in the access control system 100. As an example, two copies of an audit log 1104 may be stored—one in the memory of the mobile device 112 and another in a server of the key administrator 120. As another example, a single copy of an audit log 1104 may be temporarily stored in the mobile device 112 and then shared to a reader 108, which forwards the audit log 1104 to the key administrator 120 for secure storage. Once shared, the mobile device 112 may delete its version of the audit log 1104. As another example, the mobile device 112 may correspond to the sole repository for the entire audit log 1104 and only portions of the audit log 1104 may be retrieved by the reader 108 or some other reading device if specific portions of the audit log 1104 are requested.

The audit log 1104 may contain an entire transactional history for the mobile device 112 or for keys 132 used by the mobile device 112. The audit log 1104 may also contain information regarding the reader 108 that was provided with a particular mobile key 132 and a time/day at which the mobile key 132 was provided to the reader 108. As an example, an identifier of the reader 108 along with an identifier of the mobile key 132 may be maintained in the audit log 1104.

As the name suggests, the audit log 1104 may contain information that enables an audit to be performed on a transaction history for a mobile device 112 or for mobile keys 132 stored on the mobile device 112. The transaction history may be complete or partial. As an example of a partial transaction history, the audit log 1104 may only contain transaction information for transactions that have occurred within a specified period of time. As another example of a partial transaction history, the audit log 1104 may only contain a predetermined number of transaction entries, with the oldest transaction entries being replaced by the newer transaction entries as the mobile device 112 continues to be used.

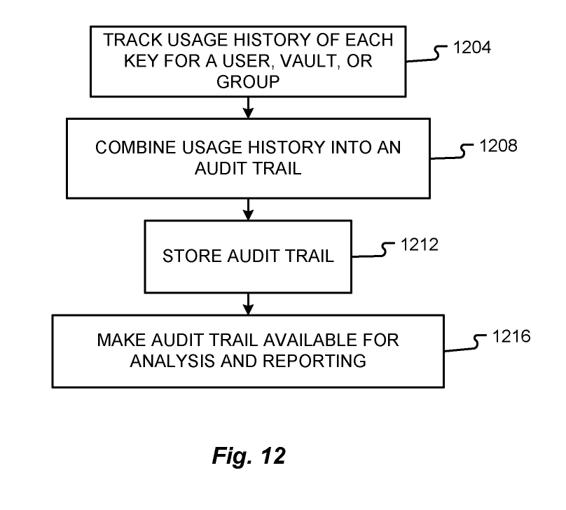

With reference now to FIG. 12, additional information regarding the use of the audit log 1104 will be described in accordance with at least some embodiments of the present disclosure. The method begins by initializing the memory of the mobile device 112 (in particular the secure area 304) to maintain an audit log 1104 that enables the mobile device 112 to track its own usage history (step 1204). Even more specifically, the mobile device 112 may be enabled to track a specific usage history for each of the keys 132 stored in the secure area 304. In some embodiments, a single audit log 1104 may be used to stored transaction history for all keys 132. In some embodiments, separate audit logs 1104 may be used to stored transaction histories for different keys 132, thereby maintaining a logical separation between keys and their respective audit logs 1104.

The method continues by allowing the mobile device 112 to interact with readers 108 and other devices and as the mobile device 112 is used, the usage history of the mobile device 112 is combined and/or collected into the audit log 1104 (step 1208). This combination of usage history, as suggested above, may include usage histories for different keys 132 stored in the secure area 304.

As the audit log 1104 is updated, the audit log 1104 may be stored within the memory of the mobile device 112 (step 1212). In some embodiments, the audit log 1104 may be secured stored in the secure area 304, meaning that the audit log 1104 can be stored and encrypted within memory of the mobile device 112. Alternatively or additionally, the audit log 1104 may be stored in some other memory remote from the mobile device 112 (e.g., a reader 108 or some other server in the access control system 100).

After it is stored, the audit log 1104 may be made available for analysis and reporting (step 1216). In some embodiments, the audit log 1104 may be stored and maintained for use only by an authorized user of the mobile device 112. In some embodiments, the audit log 1104 may be made available to security administration personnel to enable an analysis of usage history within an access control system 100. In some embodiments, the audit log 1104 itself may be securely maintained and only certain statistics or characteristics of the audit log 1104 (e.g., number of entries performed over a period of time, number of times a particular reader has been visited over a period of time, common paths that are taken within a day, etc.) may be made available to a user or security administration personnel.

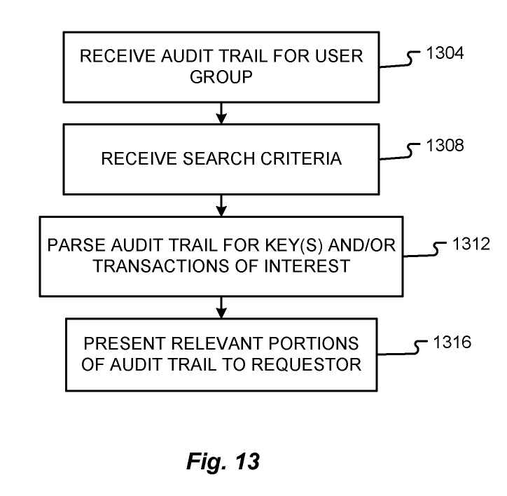

With reference now to FIG. 13, a method of analyzing an audit log for a plurality of users (e.g., a user group) will be described in accordance with at least some embodiments of the present disclosure. The method begins by receiving an audit log 1104 for a user group (step 1304). The group's audit log 1104 may correspond to a single audit log 1104 from a single source or it may correspond to a plurality of audit logs 1104 for different keys and/or users that have been combined into a single audit log 1104. The group audit log may contain information about all users with access privileges to a certain facility, building, room, or that are somehow logically related. As an example, the group audit log may contain a combination of audit logs 1104 (or audit log entries) for users in a particular department (e.g., billing, sales, executives, engineering, etc.). As another example, the group audit log may contain a combination of audit logs 1104 (or audit log entries) for users assigned to a particular location as a home location. Other logical combinations can be expressed with the group audit log.

The audit log containing information about a plurality of users may be stored and made searchable based on one or more search criteria. Accordingly, in some embodiments, the group audit log 1104 or its entries may be maintained in a searchable database or table with searchable fields.

The method continues by receiving one or more search criteria (step 1308). The search criteria may be received from an interested security administrator or from a user belonging to the user group. Alternatively or additionally, the search criteria may be received from a combination of users belonging to the user group. The search criteria may include any number of variables or search arguments related to searchable fields or data strings within the group audit log. Upon receiving the search criteria, a database interface or similar searching tool may be used to parse the group audit trail for matching keys and/or transaction of interest (step 1312). In particular, the group audit log may be searched for terms matching (entirely or partially) the search criteria. Any entry having a matching term may be returned as part of the search results (step 1316). In some embodiments, the search results presented to the requestor may also include statistics about the search criteria (e.g., “X number of entries among Y total entries in the group audit log were returned in response to the search criteria”). Portions of entries or entire entries may be returned to the requestor and presented via a printed report and/or via an electronic report (e.g., email, screen rendering on a database interface tool, etc.).

Specific details were given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Persons of ordinary skill in the art will also understand that various embodiments described above may be used in combination with each other without departing from the scope of the present disclosure.

The illustrative systems and methods of this disclosure have been described in relation to wearable devices, systems, and methods in an access control system. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should, however, be appreciated that the present disclosure may be practiced in a variety of ways beyond the specific detail set forth herein. Moreover, it should be appreciated that the methods disclosed herein may be executed via a wearable device, a mobile device, a reading device, a communication device, and/or an access server of an access control system, etc.

Furthermore, while the illustrative aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In other embodiments, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

What is claimed is:

1. A mobile device, comprising:
computer memory including a secure area that is configured to store a plurality of access control keys; and
a reader interface that enables the mobile device to deliver one or more of the plurality of access control keys to a reader based on at least one of: (i) a communication channel used between the mobile device and reader; (ii) a protocol used between the mobile device and reader; (iii) an identity of the reader; (iv) a pairing between the mobile device and a peripheral device; (v) a context determined by the mobile device; (vi) a pairing between the mobile device and a user of the mobile device; (vii) a selection made by the reader; and (viii) a history of interactions between the mobile device and the reader.

2. The mobile device of claim 1, wherein each of the plurality of access control keys stored in the secure area comprise different properties and at least two of which are administered by different entities.

3. The mobile device of claim 2, wherein a first access control key from the plurality of access control keys is used in a first physical access control system and a second access control key from the plurality of access control keys is used in a second physical access control system.

4. The mobile device of claim 3, wherein the first physical access control system corresponds to a residential access control system administered by a user of the mobile device.

5. The mobile device of claim 4, wherein the second physical access control system corresponds to at least one of a work and hospitality access control system administered by security personnel of the at least one of a work and hospitality access control system.

6. The mobile device of claim 1, wherein at least one of the plurality of access control keys comprise a profile defining conditions of key usage.

7. The mobile device of claim 6, wherein the profile comprises at least one of a channel field, a protocol field, a reader identifier field, a user log, a contextual user information field, a key information field, and a binding information field.

8. A physical access control system, comprising:
a reader that protects access to at least one physical asset, the reader including a mobile device interface that enables the reader to exchange communications with mobile devices and, based on the information exchanged with the mobile devices, determine whether or not to enable a holder of such mobile devices to obtain access to the at least one physical asset;
a key administrator provided with key administrator information that enables the key administrator to control or administer properties or privileges associated with keys that are distributed to mobile devices and used by the mobile device to provide access privileges to the reader;
a mobile device comprising:
a network interface that enables communications between the mobile device and key administrator, thereby enabling the mobile device to receive one or more keys from the key administrator;
memory having a key vault included therein, the key vault corresponding to a secure area of memory used by the mobile device to store the one or more keys received from the key administrator;
a reader interface that enables the mobile device to provide the one or more keys to the reader based on at least one of: (i) a communication channel used between the mobile device and reader; (ii) a protocol used between the mobile device and reader; (iii) an identity of the reader; (iv) a pairing between the mobile device and a peripheral device; (v) a context determined by the mobile device; (vi) a pairing between the mobile device and a user of the mobile device; (vii) a selection made by the reader; and (viii) a history of interactions between the mobile device and the reader.

9. The physical access control system of claim 8, wherein each of the plurality of access control keys stored in the secure area comprise different properties and at least two of which are administered by different entities.

10. The physical access control system of claim 9, wherein a first access control key from the plurality of access control keys is used in a first physical access control system and a second access control key from the plurality of access control keys is used in a second physical access control system.

11. The physical access control system of claim 10, wherein the first physical access control system corresponds to a residential access control system administered by a user of the mobile device.

12. The physical access control system of claim 11, wherein the second physical access control system corresponds to at least one of a work and hospitality access control system administered by security personnel of the at least one of a work and hospitality access control system.

13. The physical access control system of claim 8, wherein at least one of the plurality of access control keys comprise a profile defining conditions of key usage.

14. The physical access control system of claim 13, wherein the profile comprises at least one of a channel field, a protocol field, a reader identifier field, a user log, a contextual user information field, a key information field, and a binding information field.

15. The physical access control system of claim 8, further comprising at least one audit log that contains entries describing usage of the one or more keys by the mobile device.

16. A method, comprising:
configuring a memory of a mobile device to include a secure area of memory;
causing the mobile device to store a plurality of access control keys in the secure area of memory; and
enabling the mobile device to deliver one or more of the plurality of access control keys to a reader based on at least one of: (i) a communication channel used between the mobile device and reader; (ii) a protocol used between the mobile device and reader; (iii) an identity of the reader; (iv) a pairing between the mobile device and a peripheral device; (v) a context determined by the mobile device; (vi) a pairing between the mobile device and a user of the mobile device; (vii) a selection made by the reader; and (viii) a history of interactions between the mobile device and the reader.

17. The method of claim 16, wherein each of the plurality of access control keys stored in the secure area of memory comprise different properties and at least two of which are administered by different entities.

18. The method of claim 17, wherein a first access control key from the plurality of access control keys is used in a first physical access control system and a second access control key from the plurality of access control keys is used in a second physical access control system.

19. The method of claim 18, wherein the first physical access control system corresponds to a residential access control system administered by a user of the mobile device.

20. The method of claim 16, further comprising:
recording information describing each interaction in which the mobile device provides an access control key to a requesting entity in an audit log;
storing the audit log in the secure area of the memory; and
making the audit log available for analysis or reporting.
